(19) United States
(12) Patent Application Publication
(10) Pub. No.: US 2009/0208917 A1
(43) Pub. Date: Aug. 20, 2009

(54) DEVELOPMENTAL SYSTEM FOR TEACHING CHILDREN HEALTHY MIND, BODY AND SOCIAL HABITS

(75) Inventor: Sarah Ann Ramsey Vinch, Yigo, GU (US)

Correspondence Address: SUMMA, ADDITON & ASHE, P.A., 11610 NORTH COMMUNITY HOUSE ROAD, SUITE 200, CHARLOTTE, NC, 28277, US

(73) Assignee: EAT! DRINK! MOVE! THINK! LLC, Yigo, GU (US)

(21) Appl. No.: 12/370,654

(22) Filed: Feb. 13, 2009

Related U.S. Application Data
(60) Provisional application No. 61/065,711, filed on Feb. 14, 2008.

(51) Int. Cl. G09B 1/06; G09B 1/08; G09B 1/16; G09B 19/00

(52) U.S. Cl. 434/430; 434/127

(57) ABSTRACT

An apparatus and method for planning and tracking meals and activities comprising a display panel having a first and second side, a plurality of manipulatives for releasable attachment to the first and second sides, and an attachment device for releasably securing the display panel to a surface. A portion of the first side of the display panel bears indicia defining a category of food and a drink item. A portion of the second side of the display panel bears indicia defining an activity. The manipulatives bear indicia defining a food item, a drink item, and a serving size. In one embodiment the manipulatives and the indicia on the first and second sides of the display panel are color coordinated such that an individual may plan and track meals and activities.

### CROSS-REFERENCE TO PRIORITY APPLICATION

This application hereby claims the benefit of the Provisional Patent Application Ser. No. 61/065,711 (filed Feb. 14, 2008, in the U.S. Patent and Trademark Office) which is hereby incorporated by reference in its entirety.

### FIELD OF THE INVENTION

The invention relates to an apparatus and system for teaching children healthy habits related to nutrition and exercise.

### SUMMARY OF THE INVENTION

The invention provides a unique, early childhood focused, two-stage system, utilizing the developmental characteristics of young children in families, for teaching and tracking values of new and balanced food offered to children, healthy activities enjoyed by children and social progress made by children. By recording foods offered to a child and activities enjoyed by a child on a two-sided display panel, children, parents and caregivers receive positive reinforcement for activities such as trying new foods, learning values of food offered, showing moderation of unhealthy food choices, balancing meals, drinking water rather than other fluids, eating meals together and taking naps. By attaching color coded, magnetic manipulatives, with pictures of types of food thereon, to the front of the display panel, one or two children from a family can record food values offered to them each day. An erasable marker is used to record healthy activities for young children, including napping and eating meals with others on the back of the display panel. Stage One of this systematic invention enables parents and caregivers to begin teaching children, ages 2-8 years old, about healthy mind, body and social habits starting when they are cognitively beginning to learn about everyday choices they will make for the rest of their lives. Stage Two of the system requires a child, at a more mature cognitive level, ages 4-8 years old, to attach the same color coded magnetic manipulatives onto the front of a hanging balance display panel, thus reflecting balanced food offered throughout the day. Both developmental Steps One and Two measure food offered to children as recordable. This method deters parents and caregivers from forcing food on young children learning to eat. Positive reinforcement for the child, parent or caregiver for offering balanced food and activities encourages continual improvement and expansion of a child's balanced taste palette and active lifestyle.

Although others have invented charting systems to track food consumption or activities, my invention provides the following novel benefits:

Focuses on both food tracking and healthy activity motivations using knowledge of early childhood learning characteristics, which enable parents to begin teaching about healthy eating and activity choices much earlier than other systems.

Is versatile for family use, in that, the food value zones, from Stage One of this system, designating spaces for recommended servings of food, by the ADA (American Dietetic Association), are developmentally appropriate to use for two different age children in one family or one child at two different stages.

Has specifically color-coded attachable tokens which represent a “Rainbow Meal” when a child is offered a meal correlating to a red, orange, yellow, green, blue, and purple magnetic manipulative. The “Rainbow Meal” exemplifies a varied and balanced meal for children who are not at the developmental level to be able to understand the meaning of balance or food groups.

Has a large set of magnetic manipulatives, with food pictures thereon, for the individual to choose from. Further, my invention includes blank, write-on, erasable tokens to provide the person endless recordable food choices, much more like real life. If the food choice is not on a token, the user personalizes a blank one, color coded to that food value. Other inventions only designate a given amount of tokens symbolizing food intake recommendations per the individual without any choices for new food to learn about.

The display panel is completely waterproof. This unique feature helps the invention adapt to continual use around food in a family's kitchen.

The color coded magnetic manipulatives are to be attached in spaces within a zone designating food values, not just food groups. This helps a parent use positive language as to why the food offered is good for the child's body. Many times, naming food groups alone is not enough motivation for a young child using a food tracking system to consume the food offered.

Rewards young children for trying a new food offered (i.e., many times trying something new for young children can be a negative event and my system rewards the child for trying something new).

Deters parents and caregivers from focusing only on food consumption with young children (i.e., forcing young children to consume food is developmentally inappropriate for this age group and by offering balanced food choices and recording them, the parent or caregiver is positively reinforced without having to inappropriately force a child to eat the food).

Teaches the child and parent moderation of “Sometimes Food”, which is valued as an unhealthy consumable choice.

Gives the child, using the Stage Two display panel, immediate feedback on a balanced diet without counting servings.

Rewards young children for sharing a meal with others. Sitting down for a meal with others teaches manners, conversation and patience to young learners.

Rewards a child for rest time. Young children need rest during their day for proper growth.

The present invention provides an apparatus for planning and tracking meals and activities. The apparatus comprises a display panel having a first side and a second side, a plurality of manipulatives for releasable attachment to at least one of the first and second sides of the display panel, and an attachment device or hanging apparatus for releasably securing the display panel to a surface. The attachment device is secured to a portion of the display panel.

At least a portion of the first and second sides of the display panel may bear a plurality of indicia. One or more of the plurality of indicia on the first and second sides of the display panel and one or more of the plurality of manipulatives are color coordinated or color coded to facilitate the planning and tracking of meals and activities.

At least one of the plurality of indicia on the first side of the display panel defines a category of food, and at least one of the plurality of indicia on the first side of the display panel defines a category of drink.

At least one of the plurality of indicia on the second side of the display panel defines an activity selected from play, dance, games, ride, run, walk, build, music, share a meal, dream, create, pretend, or read, or a combination thereof.

At least one of the plurality of manipulatives bears indicia defining a food item, and at least one of the plurality of manipulatives bears indicia defining a drink item. At least one of the plurality of manipulatives provides a surface for receiving indicia (e.g., an individual may write his or her own food or drink item). At least one of the plurality of manipulatives bears indicia defining a serving size.

The display panel may be substantially circular, substantially rectangular, substantially trapezoidal, or substantially polygonal.

It will be understood that the attachment device may be a hook, a screw, a flexible band, hook and loop fasteners, or a nail.

In another embodiment, the apparatus for planning and tracking meals and activities includes a display panel having a first side and a second side, a plurality of manipulatives for releasable attachment to at least one of the first and second sides of the display panel, and an attachment device for releasably securing the display panel to a surface, the attachment device secured to a portion of the display panel.

At least a portion of the first side of the display panel bears a plurality of indicia defining a category of food. At least a portion of the first side of the display panel also bears indicia defining a category of drink.

At least a portion of the second side of the display panel bears a plurality of indicia defining an activity selected from play, dance, games, ride, run, or walk, build, music, share a meal, dream, create, pretend, or read, or a combination thereof.

At least one of the plurality of manipulatives bears indicia defining a food item, and at least one of the plurality of manipulatives bearing indicia defines a drink item.

Advantageously, one or more of the plurality of indicia on the first and second sides of the display panel and one or more of the plurality of manipulatives are color coordinated or color coded to facilitate planning and tracking of meals and activities.

At least one of the plurality of manipulatives provides a surface for receiving indicia, and at least one of the plurality of manipulatives bears indicia defining a serving size.

The invention also provides a method for planning and tracking meals and activities wherein the method comprises providing a display panel having a first side and a second side, at least a portion of the first and second sides of the display panel bearing indicia; providing a plurality of manipulatives for releasable attachment to the first and second sides of the display panel; and planning a daily food, drink, and activity schedule by arranging one or more of the plurality of manipulatives on at least one of the first and second sides of the display panel.

In one embodiment, at least a portion of the first or second side of the display panel bears a plurality of indicia. The planning step comprises selecting at least one manipulative and releasably placing the manipulative on the indicia appearing on the first side of the display panel. The planning step further comprises selecting at least another manipulative, and releasably placing the manipulative on the indicia appearing on the second side of the display panel.

The method further comprises the steps of repeating the planning step over the course of a day, and analyzing the food, drink, and activity schedule for the day.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1A—shows a front view of the Step One magnetic display panel detailing the first two of the eight food value zones; one for tracking new foods offered and one for Sometimes Food tracking. Alongside the panel is a plurality of magnetic manipulatives in proper proportion for attaching to the display panel. The term “manipulatives” is an early childhood educational term defining any set of small objects easily handled, sorted, and identified by small children for hands-on learning purposes.

FIG. 1B—shows a back view of the Step One magnetic display panel, detailing a variety of healthy, early childhood activity choices, indicated by terms and indicia for that activity, along with an erasable pen for recording the daily choices.

FIG. 2A—shows a front view of the Step One magnetic display panel with close up views of the next three of the eight food value zones, each having an example of a corresponding magnetic manipulative for each zone. The zone close-ups also detail indicia, wording, color coding and age coding which delineates two age groups for use of the system.

FIG. 2B—shows a front view of the Step One magnetic display panel with close-up views of the last three of the eight food value zones, each having an example of a corresponding magnetic manipulative for each zone. The zone close-ups also detail indicia, wording, color coding and age coding which delineates two age groups for use of the system.

FIG. 3—shows an example of a “Rainbow Meal” using specifically color coded magnetic manipulatives for each food value zone.

FIG. 4—shows a color coded blank magnetic manipulative in use with pen and sponge to clear it.

FIG. 5A—shows a front view of the Step Two magnet display panel, on a hanging apparatus, for tracking foods offered, with examples of magnetic manipulatives in proper proportion for attaching to the panel.

FIG. 5B—shows a back view of the Step Two display panel on a hanging apparatus, including choices for napping, eating with others and writing with an erasable marker.

FIG. 6A—shows a front view of the Step Two display panel, in balance, on a hanging apparatus, after a “Rainbow Meal” has been attached thereon with color coded magnetic manipulatives.

FIG. 6B—shows a front view of the Step Two display panel, out of balance, on a hanging apparatus, after an unbalanced meal has been recorded thereon with color coded magnetic manipulatives.

FIG. 7—shows washing of the front and back of both Step One and Two display panels with water and sponge.

### DETAILED DESCRIPTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Reference numerals for the figures are provided herein below:
10—front of Step One magnetic display panel.
11—tracking space for portions of food offered by parent or caregiver in Step One of the system.
11a—tracking space for attaching green color coded, magnetic manipulatives belonging to the “germ fighters” food value classification in Step Two of the system.
11b—tracking space for attaching orange color coded, magnetic manipulatives belonging to the “something sweet” food value classification in Step Two of the system.
11c—tracking space for attaching red color coded, magnetic manipulatives belonging to the “builds muscle” food value classification in Step Two of the system.
11d—tracking space for attaching blue color coded, magnetic manipulatives belonging to the “keep it simple” food value classification in Step Two of the system.
11e—tracking space for attaching purple color coded, magnetic manipulatives belonging to the “grow strong bones” food value classification in Step Two of the system.
11f—tracking space for attaching yellow color coded, magnetic manipulatives belonging to the “get you going” food value classification in Step Two of the system.
12—tracking zone for “new” foods offered.
14—“Sometimes Food” food value zone.
16—plurality of magnetic manipulatives for tracking food offered.
18—back of Step One magnetic display panel.
20—erasable marker.
22—“build” activity choice area with indicia.
24—“music” activity choice area with indicia.
26—“share a meal” activity choice area with indicia.
28—“dream” activity choice area with indicia.
30—“create” activity choice area with indicia.
32—“pretend” activity choice area with indicia.
34—“read” activity choice area with indicia.
36—“run/walk” activity choice area with indicia.
38—“ride” activity choice area with indicia.
40—“games” activity choice area with indicia.
42—“dance” activity choice area with indicia.
44—“outside play” activity choice area with indicia.
46—“germfighters” food value zone.
46L—close-up view of color coded, “germfighters”, food value zone with indicia.
48—“builds muscle” food value zone.
48N—close-up view of color coded, “builds muscle”, food value zone with indicia.
50—“get you going” food value zone.
50Q—close-up view of color coded, “get you going”, food value zone with indicia.
52—tracking space for food offered to children ages 4-8.
54—“something sweet” food value zone.
54S—close-up view of color coded, “something sweet”, food value zone with indicia.
56—“keep it simple” food value zone.
56U—close-up view of color coded, “keep it simple”, food value zone with indicia.
58—“grow strong bones” food value zone.
58X—close-up view of color coded, “grow strong bones”, food value zone with indicia.
60—example of one of a plurality of red color coded magnetic manipulatives corresponding to a tracking space from the “builds muscle” food value zone.
62—example of one of a plurality of orange color coded magnetic manipulatives corresponding to a tracking space from the “something sweet” food value zone.
64—example of one of a plurality of yellow color coded magnetic manipulatives corresponding to a tracking space from the “get you going” food value zone.
66—example of one of a plurality of green color coded magnetic manipulatives corresponding to a tracking space from the “germ fighters” food value zone.
68—example of one of the three, blue color coded magnetic manipulatives corresponding to a tracking space from the “keep it simple” food value zone.
70—example of one of a plurality of purple color coded magnetic manipulatives corresponding to a tracking space from the “grow strong bones” food value zone.
72—an example of one blank red magnetic manipulative
74—blank red magnetic manipulative labelled by hand for tracking food offered.
76—sponge for wiping off erasable marker.
80—front of Step Two magnetic display panel.
82—back of Step Two magnetic display panel.
84—hanging apparatus.
86—space for writing with erasable marker.
88—one of a plurality of red color coded magnetic manipulatives attached to a tracking space with the “builds muscle” food value classification on the Step Two magnetic display panel.
90—one of a plurality of orange color coded magnetic manipulatives attached to a tracking space with the “something sweet” food value classification on the Step Two magnetic display panel.
92—one of a plurality of yellow color coded magnetic manipulatives attached to a tracking space with the “get you going” food value classification on the Step Two magnetic display panel.
94—one of a plurality of green color coded magnetic manipulatives attached to a tracking space with the “germ fighters” food value classification on the Step Two magnetic display panel.
96—one of a plurality of blue color coded magnetic manipulatives attached to a tracking space with the “keep it simple” food value classification on the Step Two magnetic display panel.
98—one of a plurality of purple color coded magnetic manipulatives attached to a tracking space with the “grow strong bones” food value classification on the Step Two magnetic display panel.
100—Step Two magnetic display panel in balance.
102—Step Two magnetic display panel out of balance.
104—“Sometimes Food” magnetic manipulative.
106—“Sometimes Food” magnetic manipulative in use on display panel.
108—water spray.
110—hole for hanging magnetic display panel.
112—“new” food offered magnetic manipulative.
114—blank area in the middle of the back of Step One display panel for writing with erasable marker.

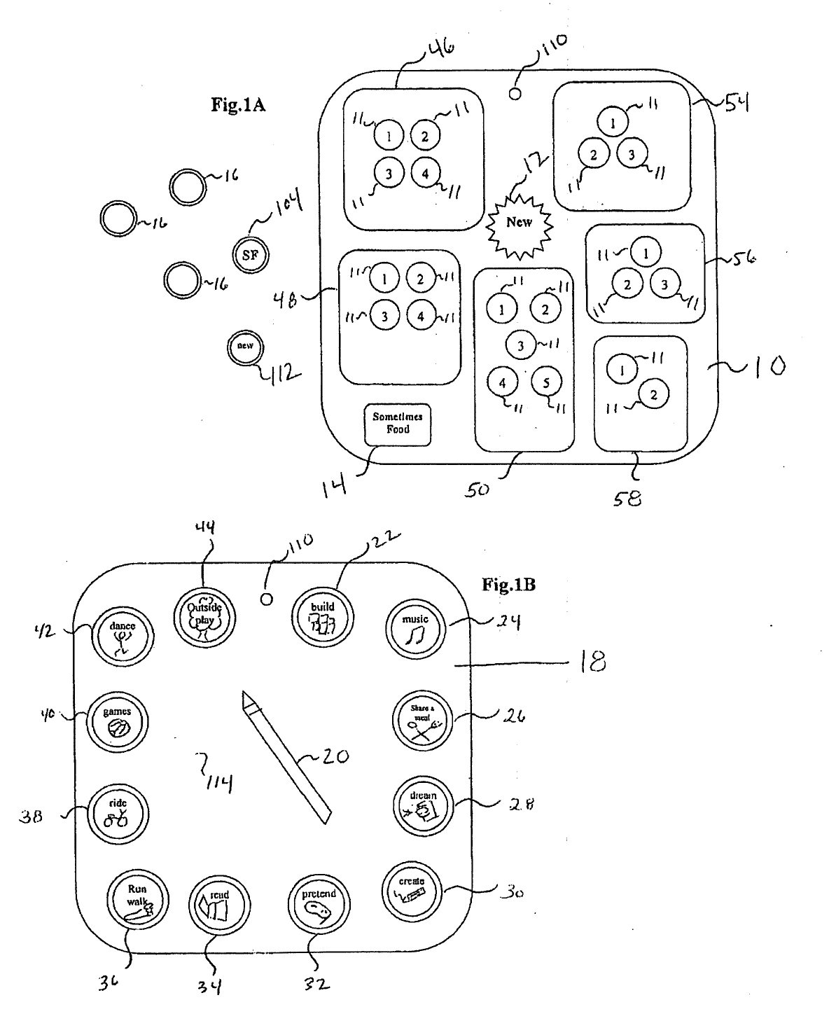

The basic pieces needed for Step One of the present system are found in FIGS. 1A and 1B. The Step One display panel 10 is made of a flat magnetic surface with a measurement of twelve inches across and a hole 110 measuring ⅜ of an inch at the panel's top, middle area. The panel has eight food value zones 12, 14, 46, 48, 50, 54, 56, 58, filled with a designated number tracking spaces 11 where a parent, child or caregiver attaches the magnetic manipulatives 16 in order to track food offered to the child on a daily basis.

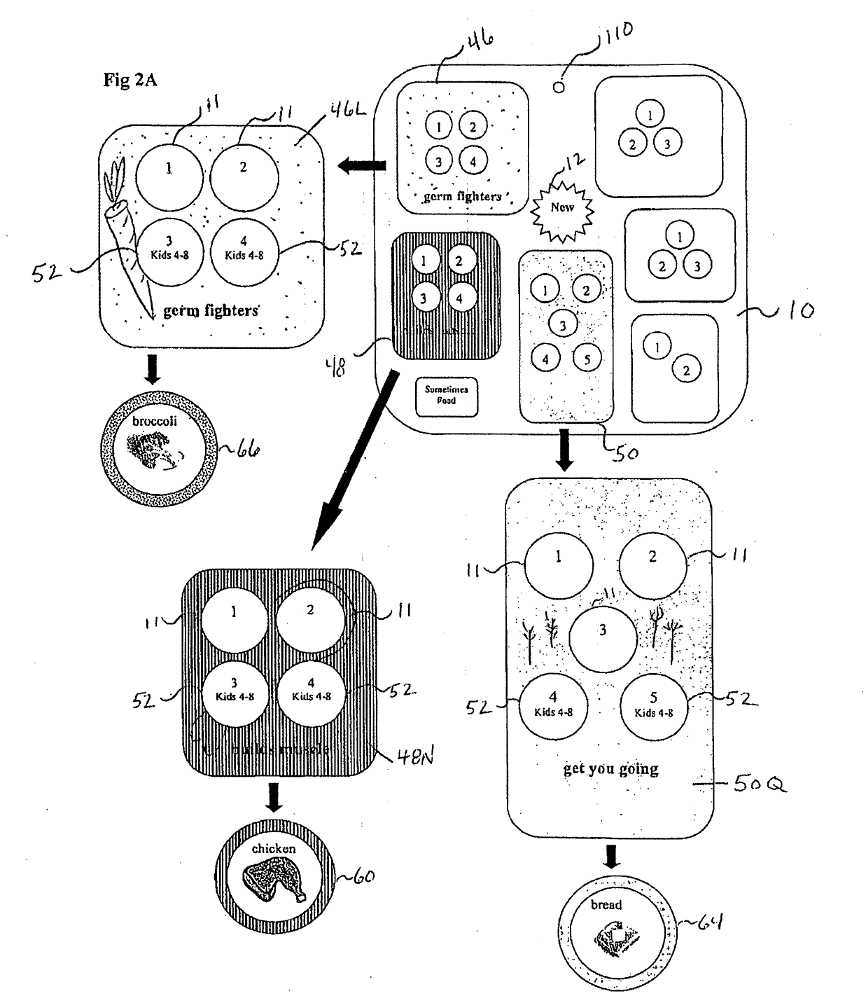

“Sometimes Food” and “New” magnetic manipulatives 104, 112 are used to mark the first two food tracking zones, “New” and “Sometimes Food” 12, 14. A large group of color coded, magnetic manipulatives are provided to the parent, child or caregiver to choose what foods will be offered at each meal or snack. The magnetic manipulatives will be discussed in more detail using FIGS. 2A and 2B.

FIG. 1B shows the back of the Step One display panel 18 of the present system. Indicia and activity terms signify the twelve activity choices for the child using the system. The activity choices on the panel are “build” 22, “music” 24, “share a meal” 26, “dream” 28, “create” 30, “pretend” 32, “read” 34, “run/walk” 36, “ride” 38, “games” 40, “dance” 42 and “outside play” 44. A child, parent or caregiver may record activities done that day with an erasable marker 20. There is also a blank area in the middle 114 for informative, creative or educational work by the child, parent or caregiver.

FIG. 2A shows detailed close-ups 46L, 48N, 50Q of three of the eight food value zones 46, 48, 50 as they are found on the front of the Step One display panel 10. Each food value zone 46, 48, 50 is shown with an example of one corresponding, color coded, magnetic manipulative 60, 64, 66 to be used on that specific food value zone's tracking space 11, 52. Each specific food value zone 46, 48, 50, its corresponding tracking spaces 11, 52 and its matching magnetic manipulatives 60, 64, 66 are all color coded to match each other and have indicia within to show an example of the type of food to be offered in that zone. The color for each food value zone is:
1. Green for the food value zone named “germ fighters” 46. This zone tracks foods offered to children that pertain to foods with similar food values of vegetables.
2. Red for the food value zone named “builds muscle” 48. This zone tracks foods offered to children that pertain to foods with similar food values of protein rich foods.
3. Yellow for the food value zone named “get you going” 50. This zone tracks foods offered to children that pertain to foods with similar food values of food made from grain.

Each food value zone has a set number of tracking spaces within it 11, 52. These tracking spaces 11, 52 signify a place to put one magnetic manipulative 60, 64, 66, equal to about one child's serving of that food offered. FIG. 2A details the indications on the tracking spaces for this system's accommodation of a second age group 52. The number of spaces 11, 52 to be filled corresponds to recommendations from the ADA in daily nutritional needs for children in two age groups, two to three years old and four to eight years old.

FIG. 2B shows detailed close-ups 54S, 56U, 58X of the last three of the eight food value zones 54, 56, 58 as they are found on the front of the Step One display panel 10. Each food value zone 54, 56, 58 is shown with an example of one corresponding, color coded, magnetic manipulative 62, 68, 70, to be used on that specific food value zone's tracking spaces 11, 52. Each specific food value zone 54, 56, 58, its corresponding tracking spaces 11, 52 and its matching magnetic manipulatives 62, 68, 70 are all color coded to match each other and have indicia within to show an example of the type of food tracked in each zone. The color for each of these food value zones is:
4. Orange for the food value zone named “something sweet” 54. This zone tracks foods offered to children that pertain to foods with similar food values of fruits.
5. Blue for the food value zone named “keep it simple” 56. This zone tracks water offered to children.
6. Purple for the food value zone named “grow strong bones” 58. This zone tracks foods offered to children that pertain to foods with similar food values of calcium rich foods.

FIG. 2B also details the indications on the tracking spaces for this system's accommodation of the second age group. The number of spaces to be filled in each food value zone 11, 52 corresponds to recommendations from the ADA for daily nutritional needs, in servings, for children in two age groups 11, 52, two to three years old and four to eight years old.

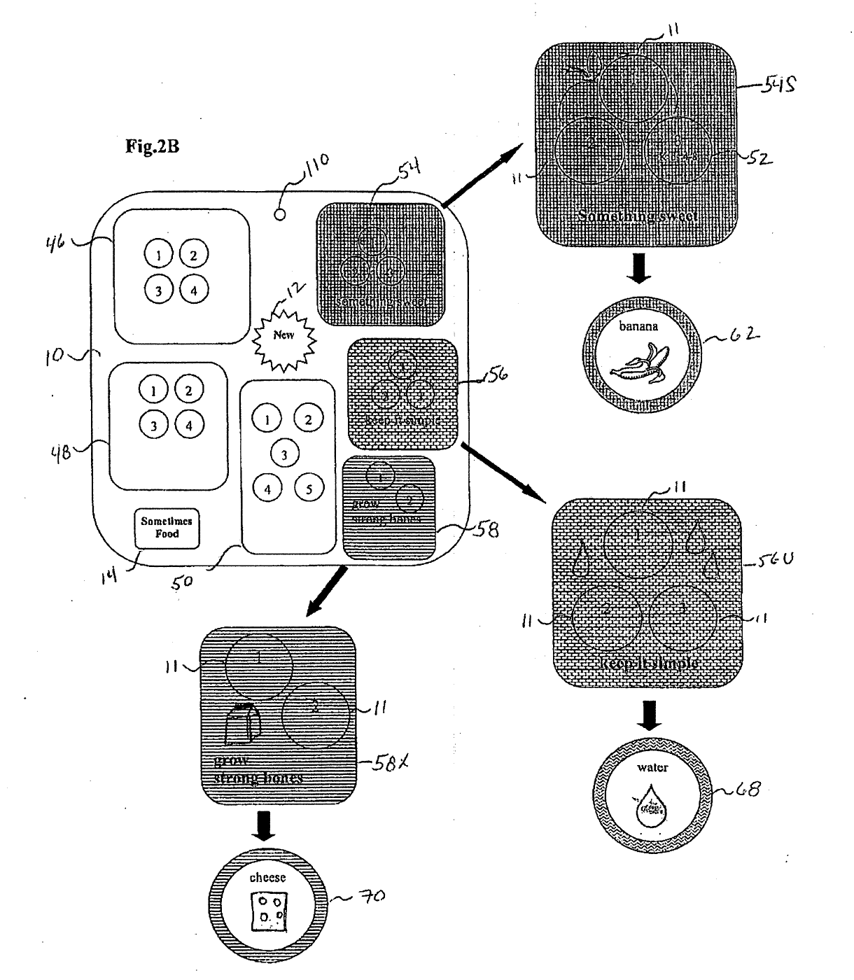

FIG. 3 is a frontal view of an example of a “Rainbow Meal”, a goal in both Step One 10 and Two 80 of the present system, where six of the plurality of specifically color coded magnetic manipulatives 60, 62, 64, 66, 68, 70 are put in the correct order of a rainbow when this food is offered to a child, exhibiting a balanced meal offered by a parent or caregiver. One food correlating to a red magnetic manipulative 60 with a picture or word of that food value offered must be used. One food correlating to an orange magnetic manipulative 62 with a picture or word of that food offered must be used. One food correlating to a yellow magnetic manipulative 64 with a picture or word of that food offered must be used. One food correlating to a green magnetic manipulative 66 with a picture or word of that food offered must be used. Water offered correlating to a blue magnetic manipulative 68 with a picture of a water drop must be used. And one food correlating to a purple magnetic manipulative 70 with a picture or word of that food offered must be used.

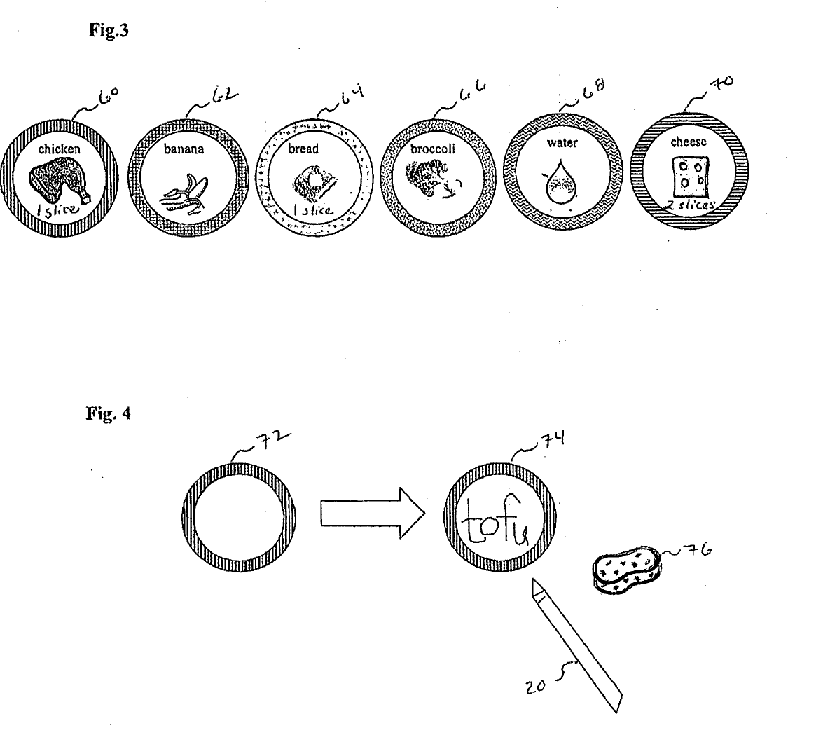

FIG. 4 exhibits an example of a blank magnetic manipulative 72 in use 74 with an erasable marker 20. Five of the eight food value classifications 46, 48, 50, 54, 58 have blank, color coded, magnetic manipulatives 72 to use when the food choice is not indicated on any of the supplied plurality of magnetic manipulatives to choose from. The blank magnetic manipulative in use 74 easily cleans off with a sponge 76. Both Steps One 10 and Two 80 of the system use the blank magnetic manipulatives.

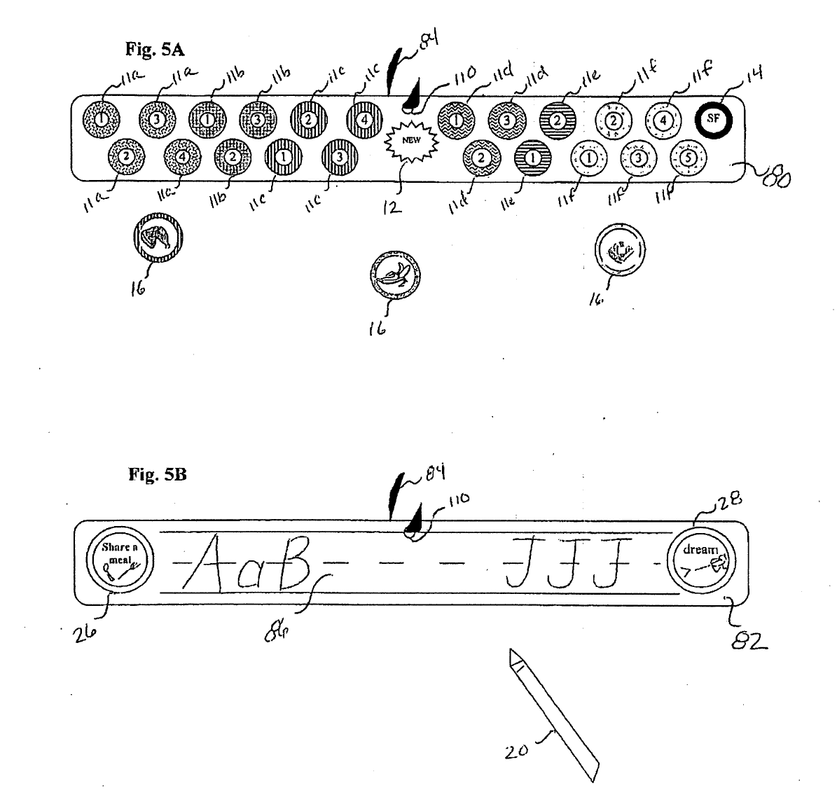

FIG. 5A is a front view of the present system's Step Two display panel 80, with food value zones to indicate new foods offered 12 and “Sometimes Food” offered 14. Food value tracking spaces 11a, 11b, 11c, 11d, 11e, 11f are also indicated, by color, for the systems other six food value zones; “germ fighters” 11a, “something sweet” 11b, “builds muscle” 11c, “keep it simple” 11d, “grow strong bones” 11e, and “get you going” 11f. Magnetic manipulatives 16 depicting food choices to be offered are shown in proportion to the magnetic display panel 16. The Step Two display Panel 80 must hang on a hanging apparatus 84 in order to be used properly.

As shown in FIG. 5B, the back of the Step Two display panel 82 has two activity choice areas 26, 28, detailed with terms and indicia for the “share a meal” 26 and “dream” 28 activity choices. There is also a space 86 for a child's, parent's or caregiver's writing with an erasable marker 20.

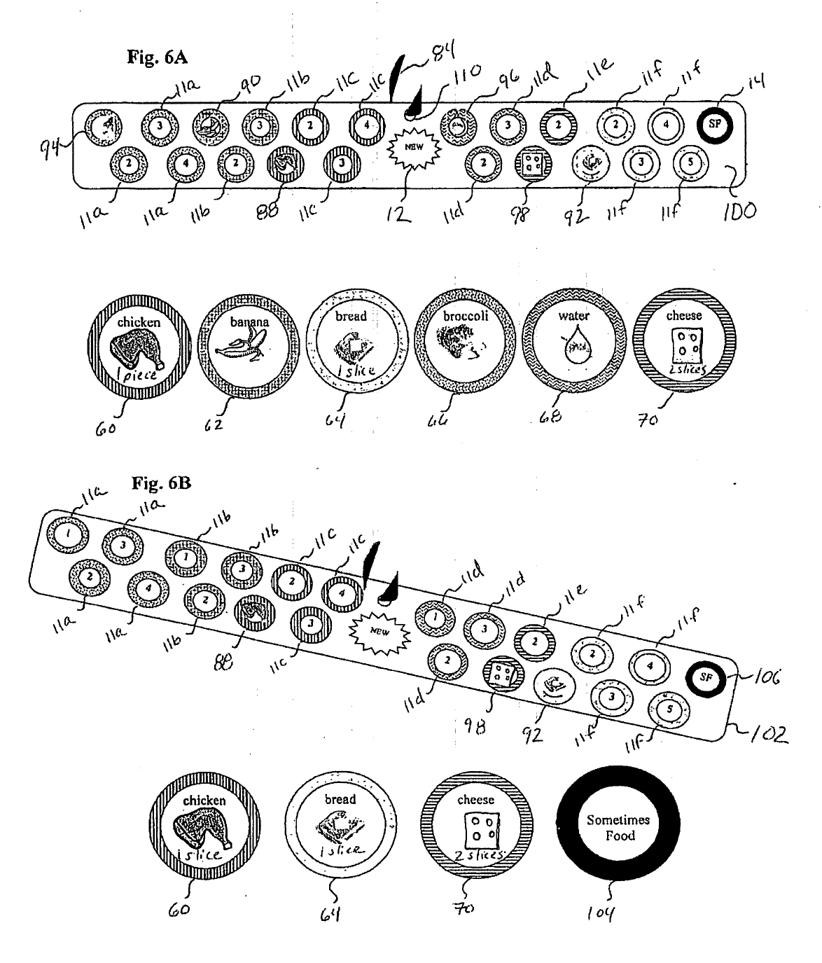

FIG. 6A shows the present system's Step Two display panel, hanging in balance 100, when six specifically color coded magnetic manipulatives 60, 62, 64, 66, 68, 70 have been attached to the correlating food tracking spaces 88, 90, 92, 94, 96, 98, after food offered and recorded was that of a “Rainbow Meal” as defined in FIG. 5A.

Whereas FIG. 6A exemplifies a balanced meal 100, FIG. 6B shows the present system's Step Two display panel hanging out of balance 102 after an unbalanced, non-Rainbow Meal had been offered and recorded with color coded magnetic manipulatives 60, 64, 70, 104.

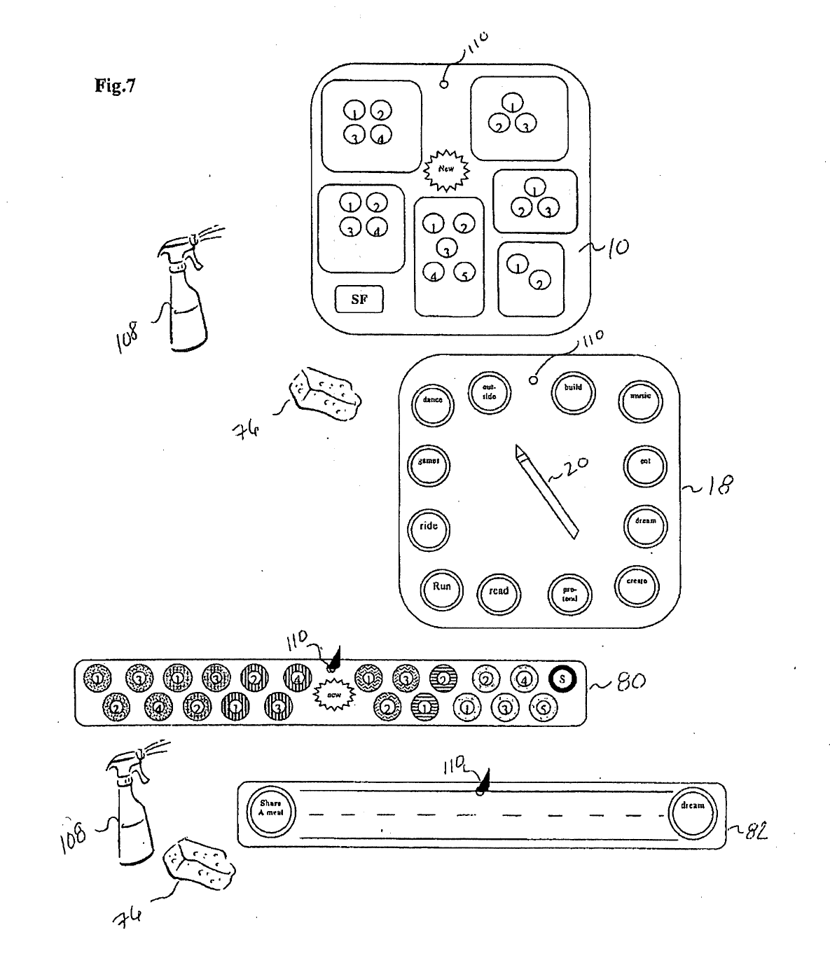

FIG. 7 shows the front and back of Steps One 10, 18 and Two 80, 82 display panels at the end of the day being cleared and washed with water 108 and sponge 76.

In operation, a child, parent, or caregiver can easily record foods offered to a child ages 2-8. Step One of the system, from FIGS. 1A and 1B, may be used for children ages two to eight. Step Two of the system, from FIGS. 5A and 5B, is intended for children ages four to eight. By simply using the unique set of magnetic manipulatives 16, 104, 112 and the magnetic display panel 10, 18, 80, 82 a parent may choose to incorporate this system into their family's everyday routine. Furthermore, a parent may choose to share it with a caregiver of the child and know what foods the child was offered and what activities were done that day while the child was in child care or school.

The large magnetic manipulative set 16 is unique because it gives the child many choices of food to be offered, much like in real life. Each magnet is color coded to the corresponding food value group, as discussed earlier in FIGS. 1A, 2A and 2B, and has a clear picture of the actual food choice thereon. In this way a child can understand the connection to the food that has been offered and the real picture on the magnetic manipulative. Some magnetic manipulatives include a child's serving size indicated with the picture 60, 64, 70. This information is more for the parent or caregiver serving the food. In this way, a parent or caregiver will know the recommended serving size of some foods that are easy for a child to consume more than one serving, such as bread 64. Some magnetic manipulatives have no serving size. In this way, the parent does not feel that they need to put an intimidating amount of a food on a child's plate just because of the serving size. For example, it is possible for a parent to record the broccoli magnetic manipulative 66 on the display panel without making their child eat a whole serving of broccoli which would be difficult for the child who may be starting to eat such foods.

The magnetic manipulatives, showing food choices that are available to be eaten, or are in the kitchen, in this system, should be on display 16 for the child to be able to locate them and play with them in order to familiarize himself with the food choices. In this case, a refrigerator or cookie sheet or other magnetic surface works well. Any magnetic manipulatives for food that are not available to be offered get put away until they become available food choices. When a child is offered food to be eaten, for instance at a meal or snack, the parent, child or caregiver would then find the matching magnetic manipulatives for each food offered 60, 62, 64, 66, 68, 70, discuss with the child the value of the food being offered by using words from the food value zones and then attach the magnetic manipulatives to the correct tracking spaces 11, 52 in the proper food value zone 12, 14, 46, 48, 50, 54, 56, 58.

As noted in FIGS. 2A and 2B, there are eight food value zones on the front of the Step One display panel 10 of this invention. Each food value zone is uniquely named for what the food does for one's body when eaten. Food value zones have been named such because it further educates the parent and caregiver about good nutrition and enables them to knowledgably inform the child as to why they should eat the food offered. Each magnetic manipulative fits into one of the following food value zones:
1. “Germ fighters” food are those choices with values of vegetables 66. This system includes potatoes, tomatoes, pickles, corn and olives in the germ fighters food value classification because they may be easier for a child to try for the first time and be successful at filling in their required food tracking spaces for that day. Vegetables help boost our immune systems and help our bodies stay strong against germs.
2. The “builds muscle” foods are those choices with values of protein rich foods 60. Protein rich foods help a body to grow and strengthen muscle.
3. “Get you going” foods have values of foods made from grain 64. Many people start their day with grains like oatmeal, cereal, and toast. High fiber foods such as those made of whole grain help to literally get a person's bowels going.
4. “Grow strong bones” foods have values of calcium rich foods 70. Calcium rich foods help strengthen growing bones.
5. The “keep it simple” food value zone correlates to water 68. It is much healthier to drink plain water than other sports or fruit drinks that are usually loaded with sugar.
6. “Something sweet” foods have values of fruits 62. Many times a sugary snack can be replaced by a sweet piece of fruit.
7. “Sometimes Food” is a zone where a parent decides what foods belong in this group. Unhealthy junk food and sugary snacks are usually considered “Sometimes Food” 14.
8. “New” food offered is a zone 12 with values of any food a child is trying new or in a new way.

Each food value zone is color coded the same as its matching magnetic manipulatives, and shows indicia of common foods found in that zone, as found in FIGS. 2A and 2B.

Using the set of color coded magnetic manipulatives, the parent, child, or caregiver can record at each meal or snack what has been offered to the child to eat. The corresponding manipulatives matching servings of food offered are then attached to the display panel 10, in the correct food value zone 12, 14, 46, 48, 50, 54, 56, 58, covering one food tracking space 11, 52 for roughly each serving offered to the child. For instance, if the child was offered peanut butter on a ricecake, with an apple and carrots for lunch, the parent, child or caregiver will locate:
1. the red colored, peanut butter magnetic manipulative 60
2. the yellow colored, cracker/ricecake magnetic manipulative 64
3. the orange colored, apple magnetic manipulative 62
4. and the green colored, carrots magnetic manipulative 66

By attaching these color coded manipulatives to the display panel, the meal has been respectively recorded as,
1. one “builds muscle” food 48
2. one “gets you going” food 50
3. one “something sweet” food 54
4. one “germ fighters” food 46

If the child was offered a peanut butter sandwich with two pieces of bread, instead of the ricecake, the parent or caregiver would need to employ the yellow, bread magnetic manipulative 64 and a blank, yellow manipulative 72 labelled bread to count the second slice of bread as offered. In this way a child cognitively connects the pieces of a meal offered to what is healthy for his body. At the same time, the parent or caregiver is receiving positive reinforcement for actually recording and knowing she or he is offering healthful food.

Another way of employing the blank magnetic manipulative 72 is if the child was offered sliced papaya instead of the apple at meal time. The plurality of manipulatives does not include papaya as a choice, thus the blank 72, orange colored magnetic manipulative needs to have papaya written on it with erasable marker 20 and attached as a “something sweet” food offered 54.

At the same time if papaya was being introduced for the first time to the child, the child may record the “New” magnetic manipulative 112 on the new food offered value zone 12 to positively reinforce the fact that the child simply tried something new. Trying something new can be scary for children at this age, but by getting rewarded for it, they may find trying something new more enjoyable and, in return, not so challenging for the parent or caregiver.

Lastly, if an unhealthy food choice was offered at this meal such as potato chips, the parent, caregiver or child would attach a “Sometimes Food” magnetic manipulative 104 to the “Sometimes Food”, food value zone 14. This recording, accounts for the one “Sometimes Food” tracking space 14 and another unhealthy food choice would have to wait until the next day.

In Step One of the present system, each of the food value zones 12, 14, 46, 48, 50, 54, 56, 58 has a set amount of food tracking spaces 11, 52. Each food tracking space pertains to 1 serving of the full number of servings, from that food classification, recommended by the ADA for the specific age groups 2-3 years and 4-8 years old. Four of the food value zones 46L, 48N, 50Q, 54S show the delineation between the ADA's recommended nutritional amounts for these two age groups. They are:
1. “Germ fighters” 46L
   a. Ages 2-3 need 3 servings per day 11
   b. Ages 4-8 need 4 servings per day 52
2. “Builds muscle” 48N
   a. Ages 2-3 need 2 servings per day 11
   b. Ages 4-8 need 3-4 servings per day 52
3. “Get you going” 50Q
   a. Ages 2-3 need 3 servings per day 11
   b. Ages 4-8 need 4-5 servings per day 52
4. “Something sweet” 54S
   a. Ages 2-3 need 2 servings per day 11
   b. Ages 4-8 need 3 servings per day 52

In this way, Step One of the present system is very versatile for family use. Two children of different ages can track food offered. Simply put, the older child may record additional servings of food offered by employing the higher number of tracking spaces 52 in the food value zones. The food tracking spaces 11, 52 of the present system may also be used by one child in two different developmental stages, when the child is 2-3 years old 11 and further when the child is 4-8 years old 52.

One goal of this system's Step One and Two is the use of a “Rainbow Meal” from FIG. 3. A “Rainbow Meal” consists of a meal where six different foods 60, 62, 64, 66, 68, 70 are offered from six different food value zones 46, 48, 50, 54, 56, 58, where each food correlates to a different color coded magnetic manipulative 60, 62, 64, 66, 68, 70 to be attached to the display panel in either Step One 10 or Two 80 of the system. A “Rainbow Meal” is made up of,
A. One red magnetic manipulative belonging to the food value zone “builds muscle” 60
B. One orange colored magnetic manipulative belonging to the food value zone “something sweet” 62
C. One yellow magnetic manipulative belonging to the food value zone “get you going” 64
D. One green magnetic manipulative belonging to the food value zone “germ fighters” 66
E. One blue magnetic manipulative belonging to the food value zone “keep it simple” 68
F. One purple magnetic manipulative belonging to the food value zone “grow strong bones” 70

As an example, from FIG. 3, a meal offered consisting of a slice of chicken and one slice cheese on a piece of bread, with ½ a banana, broccoli and a drink of water employs one of each specifically, color coded magnetic manipulative, thus a “Rainbow Meal”.

A child, parent or caregiver records the correlating magnetic manipulatives on the display panel 10, 80 every time a food is offered to the child throughout the day. As mentioned before, balanced meals are positively reinforced for the child, parent or caregiver by filling tracking spaces for food offered. Trying new foods is positively reinforced and moderation of unhealthy foods is also reinforced through accountability for that unhealthy food choice.

The backside of the Step One display panel 18 helps a parent or caregiver offer healthy mind and body activities to a young child. By recording what activities were enjoyed with an erasable marker 20, a parent, child or caregiver can accurately lead a conversation about the child's day, thus bridging communication gaps found when a child doesn't remember what he did that day, or when a child was away from his parents for the day. As seen in FIG. 1B, the symbols and words correlating to the activity choices are all healthy early childhood choices for ways to spend the day. The activity choices include, a “Share a meal” choice 26 where a child eats a meal sitting down at a table with others, and “Dream” 28 where taking a nap or having quiet time for the young child is reinforced. The recording of activities can continue throughout the day, or a parent or caregiver may want to have the child record what the child did at the end of the morning before lunch and then again before dinner or bedtime.

At the end of the day a parent or child may clear the Step One display panel 10 of magnetic manipulatives and return them to their starting point, wipe the writing off the panel 18, wash the board with a sponge 76 and water 108 if necessary, and place it where it will be used for the next day.

The Step One display panel is recommended for children ages 2-8 years old, but at the age of four a parent or caregiver may choose to try the Step Two display panel from FIGS. 5A and 5B. The Step Two display panel 80, 82 differs from the Step One display panel 10, 18 in that it is a balance scale of sorts, where the same set of color coded magnetic manipulatives 16 is used on the food tracking spaces for foods offered, and at the same time the display panel 80, which balances on a hanging apparatus 84, gives the 4-8 year old immediate feedback, by levelling or tipping to one side, showing whether the food offered for that day is that of a balanced or unbalanced diet, as seen in FIGS. 6A and 6B.

The Step Two balancing display panel stays in balance (FIG. 6A) if the food offered and recorded is of a balanced variety of foods from the system's eight food value zones. “Rainbow meals”, as mentioned earlier, balance the board (FIG. 6A). A child using the Step Two display panel can begin to make choices for food to eat for a balanced diet by looking at the board and requesting a food choice, that by placing the correlating magnetic manipulative of that food choice on the panel, the panel comes into balance. “New” foods 12 and “Sometimes Foods” 14 are also recorded.

The Step Two display panel also has activity choices on the back 82 with a writing space for an older child learning to read and write 86. The two healthy activity choices on the back are “Share and meal” 26 and “Dream” 28. Both choices are part of a healthy lifestyle of a young child. The writing space may be used by the child to write his favorite part of the day, practicing new words, numbers or doodling with an erasable marker 20. It can also be used to relay messages to parents or caregivers.

At the end of the day, the Step Two display panel 80 is cleared of magnetic manipulatives, wiped off and washed with sponge 76 and water 108 if needed, ready to begin the next day.

The present system, being extremely flexible, may be used by parents at home with small children or by parents and caregivers of children during the day while in childcare. In this way, communication between home and the family's child care arrangement is consistent with the healthy family values of the child.

This system has been developed based on developmental needs and characteristics of very young children and their family circles. Childhood obesity is a threat to many who do not learn to eat healthy and stay active early on in their development. This system extends a parent's and caregiver's knowledge of proper nutritional needs and teaching techniques to help teach and empower children to make better mind, body, and social choices throughout their lives.

This same system with changes to the numbers of food tracking spaces could also be used by pregnant women to help positively reinforce a balanced prenatal diet. Food value zones could be worded for values affecting the gestating baby and rewards for the mother could be different than the new rewarding tracking space. Activities could also be accommodating to smart activity choices for a pregnant woman.

This same system could also be changed into a larger version of the same display panel and magnetic manipulatives to be used in a larger setting, such as a school cafeteria, or a childcare classroom or greeting area. This would allow children, their parents and/or caregivers to use the system while the child is having meals away from their home, in a group setting, for lunch and possibly breakfast.

In the drawings and specification, there have been disclosed typical embodiments on the invention and, although specific terms have been employed, they have been used in a generic and descriptive sense only and not for purposes of limitation, the scope of the invention being set forth in the following claims.

1. An apparatus for planning and tracking meals and activities, said apparatus comprising:
a display panel having a first side and a second side, at least a portion of said first and second sides of said display panel bearing a plurality of indicia;
a plurality of manipulatives for releasable attachment to at least one of said first and second sides of said display panel; and
an attachment device for releasably securing said display panel to a surface, said attachment device secured to a portion of said display panel;
wherein one or more of said plurality of indicia on said first and second sides of said display panel and one or more of said plurality of manipulatives are color coordinated to facilitate planning and tracking of meals and activities.

2. A planning and tracking apparatus according to claim 1, wherein at least one of said plurality of indicia on said first side of said display panel defines a category of food.

3. A planning and tracking apparatus according to claim 1, wherein at least one of said plurality of indicia on said first side of said display panel defines a category of drink.

4. A planning and tracking apparatus according to claim 1, wherein at least one of said plurality of indicia on said second side of said display panel defines an activity.

5. A planning and tracking apparatus according to claim 4, wherein said at least one of said plurality of indicia defines an activity selected from play, dance, games, ride, run, walk, build, music, share a meal, dream, create, pretend, or read, or a combination thereof.

6. A planning and tracking apparatus according to claim 1, wherein at least one of said plurality of manipulatives bears indicia defining a food item.

7. A planning and tracking apparatus according to claim 1, wherein at least one of said plurality of manipulatives bears indicia defining a drink item.

8. A planning and tracking apparatus according to claim 1, wherein at least one of said plurality of manipulatives provides a surface for receiving indicia.

9. A planning and tracking apparatus according to claim 1, wherein at least one of said plurality of manipulatives bears indicia defining a serving size.

10. A planning and tracking apparatus according to claim 1, wherein said display panel is formed into a shape selected from a circle, a rectangular, a trapezoid, or a polygon.

11. A planning and tracking apparatus according to claim 1, wherein said attachment device is selected from a hook, a screw, a flexible band, hook and loop fasteners, or a nail.

12. An apparatus for planning and tracking meals and activities, said apparatus comprising:
a display panel having a first side and a second side, at least a portion of said first side of said display panel bearing a plurality of indicia defining a category of food, at least a portion of said second side of said display panel bearing a plurality of indicia defining an activity;
a plurality of manipulatives for releasable attachment to at least one of said first and second sides of said display panel, at least one of said plurality of manipulatives bearing indicia defining a food item, at least one of said plurality of manipulatives bearing indicia defining a drink item; and
an attachment device for releasably securing said display panel to a surface, said attachment device secured to a portion of said display panel;
wherein one or more of said plurality of indicia on said first and second sides of said display panel and one or more of said plurality of manipulatives are color coordinated to facilitate planning and tracking of meals and activities.

13. A planning and tracking apparatus according to claim 12, wherein at least a portion of said first side of said display panel bears indicia defining a category of drink.

14. A planning and tracking apparatus according to claim 12, wherein at least one of said plurality of indicia on said second side of said display panel defines an activity selected from play, dance, games, ride, run, or walk, build, music, share a meal, dream, create, pretend, or read, or a combination thereof.

15. A planning and tracking apparatus according to claim 12, wherein at least one of said plurality of manipulatives provides a surface for receiving indicia.

16. A planning and tracking apparatus according to claim 12, wherein at least one of said plurality of manipulatives bears indicia defining a serving size.

17. A method for planning and tracking meals and activities, said method comprising:
providing a display panel having a first side and a second side, at least a portion of the first and second sides of the display panel bearing a plurality of indicia;
providing a plurality of manipulatives for releasable attachment to said first and second sides of said display panel; and
planning a daily food, drink, and activity schedule by arranging one or more of the plurality of manipulatives on at least one of the first and second sides of the display panel.

18. A method of planning and tracking according to claim 17, wherein the planning step comprises:
selecting at least one manipulative; and
releasably placing the manipulative on the indicia appearing on the first side of the display panel.

19. A method of planning and tracking according to claim 17, wherein the planning step further comprises:
selecting at least another manipulative;
releasably placing the manipulative on the indicia appearing on the second side of the display panel.

20. A method of planning and tracking according to claim 17, further comprising:
repeating the planning step over the course of a day; and
analyzing the food, drink, and activity schedule for the day.
